(19) United States
(12) Patent Application Publication
(10) Pub. No.: US 2021/0146939 A1
(43) Pub. Date: May 20, 2021

(54) DEVICE AND METHOD FOR CONTROLLING A VEHICLE MODULE

(71) Applicant: ZF Friedrichshafen AG, Friedrichshafen (DE)

(72) Inventor: Bülent SARI, Friedrichshafen (DE)

(73) Assignee: ZF Friedrichshafen AG, Friedrichshafen (DE)

(21) Appl. No.: 16/622,210

(22) PCT Filed: May 15, 2018
(86) PCT No.: PCT/EP2018/062496

§ 371 Date: Dec. 12, 2019

(30) Foreign Application Priority Data
Jun. 19, 2017 (DE) 10 2017 210 156.3

(51) Int. Cl. B60W 50/04; G06F 11/07; G06F 11/16; B60W 50/00; G06N 3/04; G06F 11/18

(52) U.S. Cl. CPC B60W 50/045; G06F 11/0757; G06F 11/1641; B60W 50/0098; B60W 2420/42; G06F 11/186; B60W 2556/35; B60W 2420/52; G06N 3/04

(57) ABSTRACT

The invention provides a device for controlling a vehicle module with plausible information, which contains a multicore safety processor, configured to check processed information for plausibility. A control unit for a vehicle module is also provided, which contains a power processor, the evaluated information of which is checked for plausibility via an information interface in the safety processor of the device according to the invention. A driver assistance system process is also provided, in which a control unit according to the invention is used.

### RELATED APPLICATIONS

This application is a filing under 35 U.S.C. § 371 of International Patent Application PCT/EP2018/062496, filed May 15, 2018, claiming priority to German Patent Application 10 2017 210 156.3, filed Jun. 19, 2017. All applications listed in this paragraph are hereby incorporated by reference in their entireties.

### TECHNICAL FIELD

The invention relates to a device for controlling a vehicle module, a control unit for a vehicle module, and a driver assistance system process.

### BACKGROUND

Control devices, also referred to as electronic control units, abbreviated as ECUs, are electronic components for control and regulation. In the automotive field, ECUs are used in numerous electronic fields for controlling and regulating vehicle functions. The ECUs known from the prior art each control and regulate a vehicle function, e.g. a function for ejecting a CD from a CD player in an vehicle radio is controlled and regulated by one ECU, and the function and setting of a radio transmitter is controlled by another ECU.

In current semi-automated vehicles, over 100 functions are each controlled and regulated by individual ECUs while driving. Each additional function requires an additional ECU. In the course of development toward highly automated, fully automated, and autonomous vehicles, even more functions arise that must be controlled and regulated. In particular with respect to the amount of information in road traffic, a large number of functions must be controlled and regulated in a semi-automated vehicle to be able to acquire and evaluate all of the information to enable safe driving.

Because an ECU consumes energy in the form of computing power, power consumption increases with each function that is to be controlled and regulated. The aim is not to control and regulate each individual function with an individual ECU, but to combine numerous related functions in one ECU in order to reduce power consumption and more efficiently evaluate information.

In vehicle domains that form a functional unit there are functions that are related to one another. These vehicle domains are called vehicle domains. Examples of vehicle domains are the information system, the chassis, the drive, the interior, and safety. Examples of functions of the information system comprise operating a radio, a CD player, establishing a telephone connection, a connection to a hands-free telephone, etc. If a music CD is playing, for example, the music is paused when a telephone connection is established. These ECUs that control and regulate vehicle domains, and therefore numerous related functions, are called domain ECUs.

ECUs for vehicle must reliably and safely provide and make available the necessary functionality, in particular in the domains relating to the chassis, drive, and safety. Reliability means that the vehicle must bring occupants from a starting point to a destination without an accident, as long as the vehicle functions properly at the start. In principle, safety means that the vehicle does not represent a risk to humans. Availability means that the vehicle is operable at any time, and is not currently in a garage, e.g. for repairs.

The Functional Safety Norm ISO 26262 for the automotive field also requires that in the case of a malfunction of an ECU, in particular an electrical malfunction, e.g. if the ECU fails due to a power failure, countermeasures in the form of safety measures should ensure that unwarranted injury risks are avoided. A malfunction caused by a power failure can be avoided, for example, with a redundant power supply.

For semi-automated vehicles, domain ECUs for driver assistance systems, also referred to as “advanced driver assistance systems,” or ADAS, are the subject matter of current research. ADAS systems monitor the environment of a vehicle, e.g. by means of environment detection sensors such as a camera, evaluate these observations, and transmit corresponding information to vehicle modules to support the driver in driving safely. A domain ECU for an ADAS system is called an ADAS domain ECU. Functions controlled and regulated by an ADAS domain ECU comprise, e.g. detection of roadway markings, vehicles, traffic signs, pedestrians, etc. These functions are controlled and regulated centrally by the ADAS domain ECU.

There are also safety risks for domain ECUs, in particular ADAS domain ECUs, that process data from environment detection sensors when the ECU is not functioning properly due to power loss. By way of example, a camera may function properly as an electrical system but misunderstand and misinterpret a detected object.

### SUMMARY

This is the basis for the invention. The fundamental object of the invention is to improve the safety of the domain ECUs known from the prior art, in particular ADAS domain ECUs.

This problem is solved with a device that has features disclosed herein, a control unit with features disclosed herein, and a driver assistance system process with features disclosed herein.

Advantageous embodiments and developments are also described herein.

The device for controlling a vehicle module contains a safety processor that has at least one information interface at an input on the safety processor, and a control interface at an output on the safety processor, wherein the safety processor contains at least a first core, a second core, and a third core. A substantial aspect of the invention is that the first core is configured to carry out a plausibility control on at least one first information transmitted from the information interface to the safety processor with respect to at least one second information sent from the information interface to the safety processor, the second core is configured to carry out a second plausibility control on the first information with respect to the second information, the third core is configured to compare the results of the plausibility control carried out on the first core sent to the third core with the results of the plausibility control executed on the second core sent to the third core, and send the information, for which plausibility has been established in the first plausibility control and the second plausibility control, to the control interface, wherein the vehicle module can be controlled with the information established as plausible via the control interface.

A vehicle module is a component of a vehicle. By way of example, a steering wheel in a vehicle is a vehicle module. Electrical/electronic systems, abbreviated as E/E systems, are likewise vehicle modules. Functional units, which may comprise numerous components, also form vehicle modules.

A processor is an electronic circuit that receives and processes commands. The processor can control and regulate other electrical circuits with the results of the processing of commands, and thus advance a process.

A core refers to a part of a processor that forms a computing unit and is capable of carrying out one or more commands.

The safety processor is therefore a multicore processor in which numerous cores are located on a single chip, i.e. a semiconductor device. Multicore processors attain a high computing performance and are less expensive to implement in a chip than numerous individual cores. The safety processor is also referred to a “multicore micro-control unit,” abbreviated as “multicore MCU.”

An interface is a mechanism between at least two functional units at which an exchange of logical values, e.g. data, or physical values, e.g. electrical signals, takes place, either unidirectionally or bidirectionally. The exchange can be analog or digital. An interface can exist between software and software, hardware and hardware, and also between software and hardware or hardware and software.

Plausibility control is a method with which the value, or a result in general, is checked in general as to whether or not it is at all plausible, i.e. acceptable, evident, and/or transparent. Plausibility controls can be carried out in both hardware and software. Plausibility controls comprise, in particular, monitoring signals that can only occur in specific combinations and sequences. By way of example, measurement values can be checked with regard to their plausible value ranges and their temporal courses. The plausibility control of variables as to whether they belong to a specific type of data, or lie in a predefined value range or a predefined number of values also comprises plausibility control. Furthermore, two or more sensors that acquire different types of information are compared with one another during operation in a plausibility control in order to detect disruptions, e.g. deviations or failures. Furthermore, short circuits and/or ground contacts can be detected by means of plausibility controls.

Information is a subset of knowledge that a transmitter can transmit to a receiver via a specific medium. The first information is preferably different from the second information. By way of example, objects in a digital camera image sent from the camera to a processor via an electrical line for further processing determine first image information. Spatial distances of the objects to the camera form the second information.

The first plausibility control and the second plausibility control can differ in terms of their approaches. Hardware and software with which the plausibility controls are carried out can be checked for errors with different plausibility controls. By way of example, measurement values can be checked as whole numbers in a first plausibility control and as floating decimal numbers in a second plausibility control.

The device according to the invention has the advantage that the vehicle module is not controlled directly with processed information. A processing of information in itself can comply with ISO 26262. The information can also indicate other safety risks that are not covered in ISO 26262. By way of example, environment information may misrepresent the environment. To avoid these additional safety risks, the information is first checked for plausibility in the safety processor, in order to eliminate further safety risks. The plausibility controls determine whether hardware or software are functioning properly and which information is correct for safely controlling the vehicle module. If information is determined to be erroneous in the plausibility control, it is not sent to the control interface. The vehicle module is thus only controlled with plausible information. The vehicle module controlled with plausible information is then in a safe state. Controlling with information also means that a fusion of the information takes place when there is a plurality of information, and the vehicle module is controlled with the information resulting from the fusion. As a result, the invention provides a safety architecture for the ADAS domain ECUs in particular.

A safe state can be assumed in particular with the device according to the invention in the event that an environment is erroneously detected, because the vehicle module is controlled with plausible information in this case. As a result of the redundant signal processing of the different sensor signals, e.g. camera, radar or lidar signals, it is possible to carry out a plausibility control. It is therefore possible to detect the erroneous signal in the case of a malfunction. Damage is kept to a minimum in the case of a malfunction by the controlling of the vehicle module with plausible information. The device is thus safe with regard to malfunctions, also referred to as “fail-safe.”

The fact that the first plausibility control is carried out on the first core and the second plausibility control is carried out on the second core, wherein the second plausibility control can differ in terms of its methods from the first plausibility control, has the advantage that both hardware and software errors can be detected by the comparison in the third core. In principle, the first core computes the same thing that the second core computes, but with a different approach. If a difference is detected in the third core by the comparison of the results obtained with the first core and the second core, there is a hardware and/or software error.

In one development of the invention, the first core is configured to carry out the first plausibility control for the first information, the second information, and at least one third information sent to the safety processor via the information interface, wherein the first information, the second information, and the third information can each be controlled for plausibility with respect to one another. This makes it possible to detect erroneous information comparatively easily. If the first information is plausible with regard to the second information and the third information, for example, and the second information is plausible with regard to the third information, none of the information is erroneous. If instead, the first information is not plausible with regard to the second information, and not plausible with regard to the third information, but the second information is plausible with regard to the third information, the first information is erroneous.

Advantageously, the second core is configured to carry out the second plausibility control for the first information, the second information, and at least one third information sent to the safety processor via the information interface, wherein the first information, second information, and third information can each be controlled for plausibility with respect to one another. As a result, the second core has the same advantages as the first core. Furthermore, three pieces of information can be compared in the third core.

In one development of the invention, the results of the first plausibility control carried out on the first core and/or the results of the second plausibility control carried out on the second core form a majority selection of the information with the greatest plausibility. The information that is not most plausible with respect to the other information is erroneous. The majority selection is also known as “voting.” If three pieces of information are controlled for plausibility, and one of these is determined to be erroneous, only two of the three pieces of information are sent to the control interface for controlling the vehicle module. This majority selection is also referred to as “2oo3 voting,” i.e. “two out of three voting.”

The safety processor preferably contains, in particular, a redundant power source for the first core, the second core and the third core. Redundancy is the additional presence of functionally identical or comparable resources of a technological system, if these are not normally needed when functioning correctly. If a power supply fails due to a malfunction, the device can still be controlled by the additional redundant power supply. With a power failure in a single power source to the safety processor, the entire safety processor, with the first, second, and third core, would malfunction. A failure of numerous components of this type resulting from a single cause or single event is referred to as a “common cause failure.” The redundant power supply thus prevents a common cause failure resulting from a power failure in a power source.

The safety processor preferably has a monitoring device for the first core, second core, and third core in particular. The monitoring device, also known as a “watchdog,” is a component in a system that monitors the functions of other components, in this case the safety processor, in particular the first, second, and third cores. If a possible error is detected, this is indicated in accordance with safety conventions, or an appropriate jump instruction is given that clears up the pending problem. The term “watchdog” comprises both hardware watchdogs as well as software watchdogs. The hardware watchdog is an electronic component that communicates with the component that is monitored. The software watchdog is a checking software in the component that is to be monitored, which checks whether all of the important program modules are correctly executed in a predefined time period, or whether a module requires too much time for the processing. Watchdogs can be implemented in particular in safety-relevant applications, and enable a monitoring of E/E systems for compliance with ISO 26262.

The information interface is preferably a redundant information interface. As a result, if the information interface fails, an additional information interface is available that operates the device in a controllable state.

The vehicle control unit according to the invention has a device according to the invention and a power processor, wherein the information interface of the device is located between the power processor and the safety processor, with the features that the power processor contains an acquisition device and an evaluation unit, the acquisition device is configured to record, i.e. acquire, at least a first signal and a second signal the evaluation unit is configured to generate at least a first information from the first signal and a second information from the second signal, and at least the first information generated from the first signal and the second information generated from the second signal can be sent to the safety processor for controlling the vehicle module. The control unit according to the invention offers the advantage that the information generated from the signals by the evaluation unit is not used directly for controlling the vehicle module, but instead is first controlled for plausibility by means of the device according to the invention. As a result, the vehicle module is only controlled with plausible information, and not with erroneous information.

According to a preferred embodiment of the invention, the power processor has at least one first channel and a separate second channel, wherein the first signal can be acquired in the first channel, and the first information can be generated from the acquired first signal, and wherein the second signal can be acquired in the second channel, and the second information can be generated independently of the first information. As a result, it is ensured that the first signal and the second signal are processed independently. According to the ISO Norm 26262, this ensures a freedom from interference. An error in channel 2 does not cause an error in channel 1, and vice versa, due to the independence.

The power processor preferably has a redundant power supply, in particular for the first channel and second channel, or for the acquisition device and the evaluation unit. The redundant power supply prevents a common cause failure caused by a power failure in a power supply.

In one development of the invention, the power processor has a monitoring device, in particular for at least the first channel and the second channel, a so-called “watchdog.” The watchdog can be a hardware and/or software watchdog.

According to a particularly preferred embodiment of the invention, the evaluation unit exhibits artificial intelligence. Artificial intelligence simulates human intelligence, i.e. it is attempted to construct or program a computer that can process problems autonomously. Artificial intelligence can be implemented in particular with an artificial neural network. An artificial neural network is an algorithm executed on an electronic circuit, which is programmed based on the neural network of the human brain. Functional units of an artificial neural network are artificial neurons, the output of which results in general in a value of an activation function evaluated over a weighted sum of the inputs plus a systematic error, the so-called bias. Artificial neural networks are taught or trained by testing numerous predefined inputs with various weighting factors and activation functions, in a manner similar to that with the human brain. The training of an artificial intelligence with predetermined inputs is referred to as machine learning. A subset of machine learning is deep learning, so-called “deep learning,” in which a series of hierarchical layers of neurons, so-called “hidden layers,” is used for carrying out the process of machine learning.

An evaluation unit with artificial intelligence can process signals more efficiently than a deterministic evaluation unit. In particular, the algorithm forming the basis of the artificial intelligence can be executed on a graphics processing unit, a so-called “Graphics Processing Unit,” abbreviated as GPU. A GPU has the advantage that it can process numerous processes simultaneously in parallel, thus increasing the efficiency of the evaluation unit.

For practical purposes, the signals acquired by the acquisition device are signals from environment sensors, in particular camera signals, radar signals, and/or lidar signals. Environment sensors provide input signals for driver assistance systems. If it is determined with the device according to the invention, for example, that the camera information is not plausible with respect to the radar information, but is plausible with respect to the lidar information, and the radar information is not plausible with respect to the lidar information, the radar information is then determined to be erroneous.

It is particularly preferred that the vehicle module comprises a vehicle domain, in particular concerning infotainment, the chassis, drive, interior and/or safety.

A driver assistance system with a control unit according to the invention is also provided according to the invention.

A control unit according to the invention is used with the driver assistance system process according to the invention. The driver assistance system process according to the invention comprises the following steps:
acquiring signals from the environment of a vehicle with the acquisition device in the power processor,
evaluating the signals and generating information from the signals in separate channels of the power processor by means of the evaluation unit,
forwarding the information to the safety processor via the information interface,
executing the first plausibility control for each information with all of the other information on the first core of the first safety processor, wherein a majority selection of the information that exhibits the greatest plausibility with respect to the other information takes place,
executing the second plausibility control for each information with all of the other information on the second core of the safety processor, wherein a majority selection of the information that exhibits the greatest plausibility with respect to the other information takes place,
forwarding the results of the plausibility control executed on the first core and the results of the second plausibility control executed on the second core to the third core of the safety processor,
comparing the results of the first plausibility control and the second plausibility control in the third core,
forwarding the information for which plausibility is determined in the first plausibility control and the second plausibility control to the control interface, and
controlling the vehicle module with the information determined to be plausible.

The driver assistance system process according to the invention ensures that only that information that has been classified as safe by means of the plausibility controls is used for controlling the vehicle module.

### BRIEF DESCRIPTION OF THE DRAWINGS

The invention shall be explained in detail in reference to the following drawings. Therein:

FIG. 1: shows an exemplary embodiment of the device according to the invention;

FIG. 2: shows an exemplary embodiment of a control unit according to the invention; and

FIG. 3: shows an exemplary embodiment of a driver assistance system process according to the invention.

Identical reference symbols indicate identical or functionally identical features. For purposes of clarity, only the respective relevant reference symbols are given in the respective figures.

### DETAILED DESCRIPTION

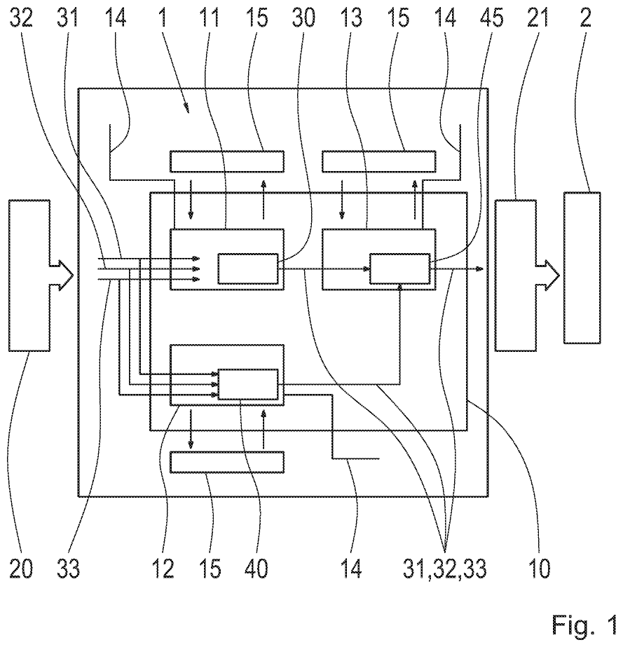

FIG. 1 shows a device 1 according to the invention for controlling a vehicle module 2. The device 1 contains an information interface 20, a safety processor 10, and a control interface 21. A first information 31, second information 32, and third information 33 are sent to the safety processor 10 via the information interface 20. The safety processor 10 has a first core 11, a second core 12, and a third core 13. Each individual core is connected to a redundant power supply 14. Furthermore, each core is monitored by a monitoring device 15.

It is also within the scope of the invention that the first information 31, second information 32, and third information 33 are each input to the device 1 as a two-channel object.

The information 31, 32, 33 are checked against each other for plausibility in a first plausibility control 30 in the first core 11. The information 31, 32, 33 are checked against each other in the second core 12 by means of a second plausibility control 40, which differs from the first plausibility control 30.

If the first information 31 is environment information acquired with a camera, the second information 32 is information acquired with a radar, and the third information 33 is information acquired with a lidar, the majority selection is based on the following majority voter formula:

| | |
|---|---|
| 1: not plausible | |
| 0: plausible | Majority voter |

| | Camera/ | Camera/ | Radar/ | Erroneous |
|---|---|---|---|---|
| | Radar | Lidar | Lidar | Information |
| Combinations | 0 | 0 | 0 | None |
| Combinations | 1 | 0 | 0 | None |
| Combinations | 0 | 1 | 0 | None |
| Combinations | 0 | 0 | 1 | None |
| Combinations | 1 | 1 | 0 | Camera |
| Combinations | 0 | 1 | 1 | Lidar |
| Combinations | 1 | 0 | 1 | Radar |
| Combinations | 1 | 1 | 1 | All |

If, for example, the camera information 31 is plausible with respect to the radar information 32, but not with the lidar information 33, and the radar information 32 is not plausible with respect to the lidar information 33, then the device 1 realizes that the lidar information 33 is erroneous.

The information 31, 32, 33 determined to be plausible with respect to one another in the first plausibility control 30 and the second plausibility control 40 are sent to the third core 13, in which a comparison 45 of the information takes place. If the information determined to be plausible in relation to one another in the first core 11 is also recognized as plausible information in the second core 12, as can be determined by a comparison 45, the vehicle module 2 is controlled via the control interface 21 with the plausible information.

If the results of the comparison show that the information determined to be plausible in the first core 11 differs from the information determined to be plausible in the second core 12, a hardware and/or software error is detected by the third core 13.

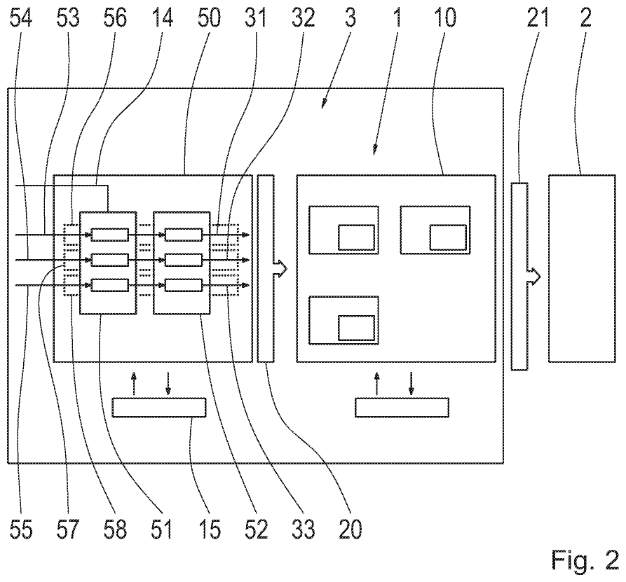

FIG. 2 shows an embodiment of a control unit 3 according to the invention. A power processor 50 is combined with a safety processor 10 by the control unit 3 via the information interface 20 located between the power processor 50 and the safety processor 10.

The power processor has an acquisition device 51 and an evaluation unit 52. The acquisition device 51 has a redundant power supply 14. A first signal 53, second signal 54, and third signal 55 are accumulated in the acquisition device. The signals 53, 54, and 55 can be signals from environment sensors, for example. By way of example, the first signal 53 can be a signal from a camera sensor, the second signal 54 can be the signal from a radar sensor, and the third signal 55 can be the signal from a lidar sensor.

The signals 53, 54, 55 are acquired and processed in separate channels in the power processor, specifically a first channel 56, second channel 57 and third channel 58.

Corresponding information 31, 32, 33 is generated from the signals 53, 54, 55 in the evaluation unit 52, which are sent to the safety processor 1 via the information interface 20. The information from a camera signal 53, for example, is then a corresponding camera image. The camera image can be an image of the area to the front, to the rear, or to the side of a vehicle.

The evaluation unit 52 exhibits artificial intelligence. The artificial intelligence is formed by an artificial neural network that has been trained to identify traffic situations.

The function of the power processor 50 is monitored with a watchdog 15.

A high performance processor is used in particular as the power processor 50. The chip on which the power processor 50 is implemented is also known as a performance or power chip. A processor with less capacity can be used as the safety processor.

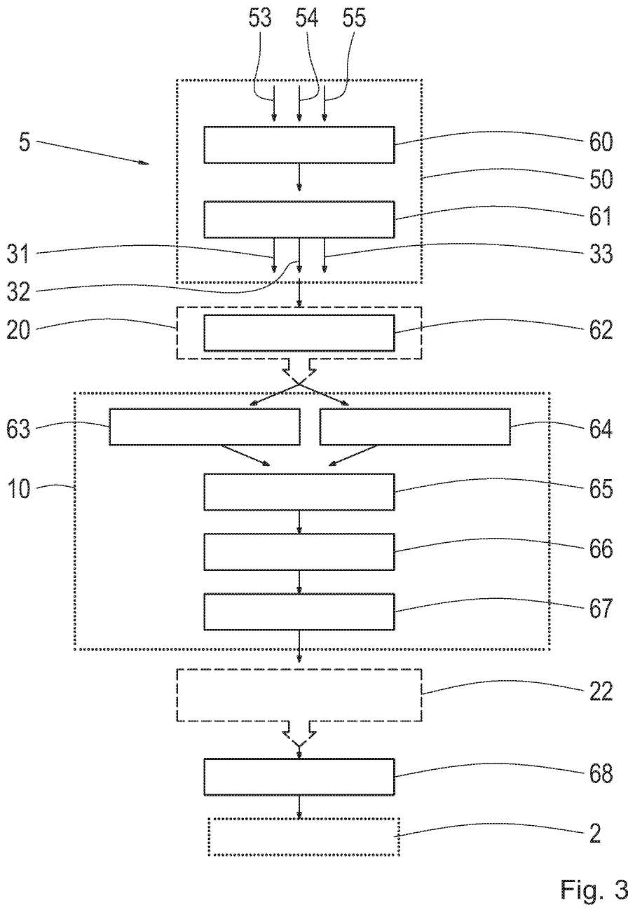

FIG. 3 shows an exemplary embodiment of a driver assistance system process 5 according to the invention, which can be executed with a driver assistance system 4. The signals 53, 54, and 55 are first acquired in the acquisition step 60 by means of the acquisition device 51. The signals 53, 54, and 55 are subsequently evaluated in the evaluation step 61 in the evaluation unit 52. The acquisition 60 and evaluation 61 of the signals 53, 54, and 55 representing the information 31, 32, and 33, respectively, takes place in the power processor 50.

The evaluated information 31, 32, and 33 are sent to the safety processor 10 in the forwarding step 62 via the information interface.

The following steps take place in the safety processor 10: the first plausibility control 30 is executed 63 in the first core 11. The second plausibility control 40 is executed 64 in the second core 12. The results of the first plausibility control 30 executed in the first core 11 and the results of the second plausibility control 40 executed in the second core 12 are sent to the third core 13 of the safety processor in the forwarding step 65. The results of the plausibility controls 30 and 40 are compared 66 in the third core 13 of the safety processor 10. The information determined to be plausible in the first plausibility control 30 and the second plausibility control 40 is then forwarded 67 to the vehicle module 2 via the control interface 22, wherein the vehicle module 2 is controlled with the information determined to be plausible in the actuation step 68.

A vehicle module can be controlled in the scope of the invention such that the control can be perceived hapticly. By way of example, a steering wheel can be actuated when it has been determined that the vehicle is not in the driving lane, such that the steering wheel vibrates, which is then perceived by the driver with his sense of touch. The actuation can also be visible or audible, or it can take place via actuators, in particular mechatronic actuators.

### REFERENCE SYMBOLS

1 device
2 vehicle module
3 control unit
4 driver assistance system
5 driver assistance system process
10 safety processor
11 first core
12 second core
13 third core
14 power supply
15 monitoring device
20 information interface
21 control interface
30 first plausibility control
31 first information
32 second information
33 third information
40 second plausibility control
45 comparison
50 power processor
51 acquisition device
52 evaluation unit
53 first signal
54 second signal
55 third signal
56 first channel
57 second channel
58 third channel
60 acquisition
61 evaluation
62 forwarding information
63 execution of a first plausibility control
64 execution of a second plausibility control
65 forwarding
66 comparison
67 forwarding of plausible information
68 actuation

1. A device for controlling a vehicle module comprising:
a safety processor comprising:
at least one information interface at an input of the safety processor;
a control interface at an output of the safety processor;
at least one first core;
at least one second core; and
at least one third core;
wherein the first core is configured to execute a first plausibility control of at least one first information sent to the safety processor via the information interface with respect to at least one second information sent to the safety processor via the information interface;
wherein the second core is configured to execute a second plausibility control of the first information with respect to the second information;
wherein the third core is configured to:
execute a comparison of a result of the plausibility control executed on the first core forwarded to the third core with a result of the second plausibility control executed on the second core forwarded to the third core; and
forward the information determined to be plausible in the first plausibility control and the second plausibility control to the control interface; and
wherein the vehicle module can be controlled via the control interface with the information determined to be plausible.

2. The device according to claim 1, wherein the first core is further configured to execute the first plausibility control for the first information, the second information, and at least one third information sent to the safety processor via the information interface, wherein the first information, the second information, and the third information can each be checked for plausibility with respect to one another.

3. The device according to claim 1, wherein the second core is configured to execute the second plausibility control for the first information, the second information, and at least one third information sent to the safety processor via the information interface, wherein the first information, the second information, and the third information can each be checked for plausibility with respect to one another.

4. The device according to claim 2, wherein the results of the first plausibility control executed on the first core is a majority selection of the information with the greatest plausibility.

5. The device according to claim 1, wherein the safety processor has a redundant power supply for the first core, the second core, and the third core.

6. The device according to claim 1, wherein the safety processor has a monitoring device for the first core, the second core, and the third core.

7. The device according to claim 1, wherein the information interface is a redundant information interface.

8. A control unit for a vehicle module, the control unit comprising:
the device according to claim 1; and
a power processor;
wherein the information interface of the device is located between the power processor and the safety processor;
wherein the power processor contains an acquisition device and an evaluation unit;
wherein the acquisition device is configured to acquire at least one first signal and at least one second signal;
wherein the evaluation unit is configured to generate at least one first information from the at least one first signal and at least one second information from the at least one second signal; and
wherein at least the at least one first information and the at least one second information is sent to the safety processor for controlling the vehicle module.

9. The control unit according to claim 8, wherein the power processor contains at least one first channel and a separate second channel, wherein the first signal can be acquired in the first channel, and the first information can be generated from the acquired first signal, and wherein the second signal can be acquired in the second channel, and the second information can be generated independently of the first information.

10. The control unit according to claim 8, wherein the power processor contains a redundant power supply for at least one of the first channel, the second channel, the acquisition device, or the evaluation unit.

11. The control unit according to claim 8, wherein the power processor contains a monitoring device for at least the first channel and the second channel.

12. The control unit according to claim 8, wherein the evaluation unit executes an artificial neural network.

13. The control unit according to claim 8, wherein the at least one first signal and the at least one second signal acquired by the acquisition device are from environment sensors.

14. The control unit according to claim 8, wherein the vehicle module is associated with at least one of an infotainment domain of a vehicle, a chassis domain of the vehicle, a drive domain of the vehicle, an interior domain of the vehicle, or a safety domain of the vehicle.

15. A driver assistance system that has a control unit according to claim 8.

16. A driver assistance method comprising:
acquiring a first signal, a second signal, and a third signal from an environment of a vehicle with an acquisition device of a power processor of a control unit;
evaluating, by an evaluation unit of the power processor, the first signal, the second signal, and the third signal and generating, by the evaluation unit, first information from the first signal, second information from the second signal, and third information from the third signal in separate channels of the power processor;
forwarding the first information, the second information, and the third information to a safety processor coupled to the power processor via an information interface of the safety processor;
executing a first plausibility control for each of the first, second, and third information with respect to each other on a first core of the safety processor, wherein a majority selection of at least one of the first, second, or third information that is most plausible with respect to each other takes place;
executing a second plausibility control for each of the first, second, and third information with respect to each other on a second core of the safety processor, wherein a majority selection of at least one of the first, second, or third information that is most plausible with respect to each other takes place;
forwarding a result of the first plausibility control executed on the first core and a result of the second plausibility control executed on the second core to a third core of the safety processor;
comparing the results of the first plausibility control and the second plausibility control on the third core;
forwarding the information for which plausibility has been established in the first plausibility control and the second plausibility control to a control interface at an output of the safety processor; and
controlling a vehicle module with the information determined to be plausible.

17. The control unit according to claim 13, wherein the at least one first signal and the at least one second signal are at least one of camera signals, radar signals, or lidar signals.
